(19) United States
(12) Patent Application Publication
(10) Pub. No.: US 2021/0326793 A1
(43) Pub. Date: Oct. 21, 2021

(54) WORKFLOW MANAGEMENT SYSTEM

(71) Applicant: RICHARD FRANKEL, MEDIA, PA (US)

(72) Inventor: RICHARD FRANKEL, MEDIA, PA (US)

(21) Appl. No.: 17/178,206

(22) Filed: Feb. 17, 2021

Related U.S. Application Data
(60) Provisional application No. 63/011,624, filed on Apr. 17, 2020.

(51) Int. Cl. G06Q 10/06; G06Q 10/10; G06F 16/18

(52) U.S. Cl. CPC G06Q 10/06316; G06F 16/1815; G06Q 10/063118; G06Q 10/103

(57) ABSTRACT

A computer-implemented task management system and method for implementing the same are provided. The system and method can include a task period journal module configured to provide a task period journal having a task table that lists one or more tasks a user or team of users is assigned to complete and a notepad for documenting remarks about the one or more tasks, and a Kanban board module configured to provide a Kanban board having one or more Kanban lanes and one or more Kanban cards in at least one of the one or more Kanban lanes, wherein each of the one or more Kanban cards represents a particular task, and each of the one or more Kanban cards is configured to receive a user inputted modification.

### RELATED APPLICATIONS

This application claims the benefit of priority under 35 U.S.C. § 119(e) of U.S. Provisional Application Ser. No. 63/011,624 filed on Apr. 17, 2020, the content of which is relied upon and incorporated herein by reference in its entirety.

### FIELD

The present disclosure relates to a computer-implemented system and method for improving workflow and task management.

### BACKGROUND

Task management systems are used by individuals or groups of people who collaborate with one another to accomplish a shared goal. Various aspects of a task, such as its status, timelines, priority, update notifications, and resource allocation, are handled by the software, which enables group members to plan and schedule multiple tasks according to the set deadlines.

Existing task management products tend to have fewer features than project management platforms because they are intended to be used by entire teams, rather than just a manager. The focus of task management features is generally execution-oriented, targeted on organizing and managing tasks. Such features include to-do lists, which are typically organized by project in some form that displays tasks that need to be completed by an individual or team; audit trails, which allow a user to see the entire history of a task and any modifications that have been made to it; and mobile support for smart devices, which are usually in the form of an app that syncs a user's information and tasks to their device. Some task management applications can integrate with email clients, such as Gmail or Microsoft Outlook, or cloud storage services, such as Dropbox or Google Drive. Some task management applications allow users to share documents directly through the application; offer version management and control features that provide access to the latest version of a document and store past versions of a document. Some task management applications enable the creation and assignment of team projects, including the responsibilities for task completion. And some systems include automatic notifications sent to individuals or a team as soon as something happens, such as task completion, deletion, or a new feature of the tool. Such notifications can be customized with various options or triggers.

Despite offering a variety of features, existing task management applications fail to provide a system that offers a personal dashboard and a team dashboard for displaying shared tasks such that the display of the personal dashboard of tasks (e.g., a Kanban board) can be customized in a manner that is unique to an individual user without changing the corresponding display of the team dashboard of tasks. Existing task management applications also fail to provide a system that retrieves data associated with the tasks on each of the individual computing devices of the plurality of users, aggregate the retrieved data, and push the aggregated data to each of the individual computing devices for display on the team dashboard and the personal dashboard. Furthermore, existing systems fail to provide a method for automatically saving user-entered and task-related notes to a task period journal such that archived journal entries can be later called, cloned, and reused for new tasks. For the foregoing reasons, there is a need for an improved workflow and task management system.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

In various embodiments, a computer-implemented task management system is provided. The system can comprise: at least one computing device in operable communication with a network; a memory that stores computer-executable instructions; a processor in communication with the memory and configured to execute the computer-executable instructions, wherein the computer-executable instructions invoke one or more application program components, comprising: a task period journal module configured to provide a task period journal comprising a task table listing one or more tasks a user or team of users is assigned to complete and a notepad for documenting remarks about the one or more tasks, wherein one or more snapshots of the task period journal is archivable in a registry comprising each of the one or more snapshots related to the one or more tasks; and a display module configured to provide a graphical user interface for displaying a task period journal and the registry; wherein the system is configured to create a copy of an archived snapshot and push the task period journal from the copy of the archived snapshot to the display on the graphical user interface when the user inputs an instruction for the system to call the archived snapshot of the task period journal from the registry.

In various embodiments, the system can comprise: at least one computing device in operable communication with a network; a memory that stores computer-executable instructions; a processor in communication with the memory and configured to execute the computer-executable instructions, wherein the computer-executable instructions invoke one or more application program components, comprising: a Kanban board module configured to provide a Kanban board comprising one or more Kanban lanes and one or more Kanban cards in at least one of the one or more Kanban lanes, wherein each of the one or more Kanban cards represents a particular task, and each of the one or more Kanban cards is configured to receive a user inputted modification; and a display module configured to provide a graphical user interface for displaying the one or more Kanban cards on the Kanban board displayed on a personal dashboard, a team dashboard, or a project dashboard; wherein, when the one or more Kanban cards is displayed on the Kanban board of the team dashboard and accessible by a plurality of users, and a particular Kanban card is moved from a first Kanban lane to a second Kanban lane on the Kanban board, each user of the plurality of users, having an independent computing device for displaying the Kanban board on a graphical user interface, will see the one or more Kanban cards displayed in an identical position on the Kanban board before and after the particular Kanban card is moved; and wherein, when the one or more Kanban cards is displayed on the Kanban board of the personal dashboard, and the particular Kanban card is moved from the first Kanban lane to the second Kanban lane on the Kanban board displayed on the computing device of the first user, the particular Kanban card will not be moved on the Kanban board of the personal dashboard for each of the plurality of users other than the first user.

In various embodiments, a computer implemented method of retrieving a first archived snapshot entry of a task period journal from a registry and archiving a second snapshot entry of the task period journal in the registry is provided. The method can comprise: providing a computer-implemented task management system for carrying out the method, the system, comprising: at least one computing device in operable communication with a network; a memory that stores computer-executable instructions; a processor in communication with the memory and configured to execute the computer-executable instructions, wherein the computer-executable instructions invoke one or more application program components, comprising: a task period journal module configured to provide the task period journal comprising a task table listing one or more tasks a user or team of users is assigned to complete and a notepad for documenting remarks about the one or more tasks, wherein the one or more snapshots of the task period journal is archivable in the registry comprising each of the one or more snapshots related to the one or more tasks; and a display module configured to provide a graphical user interface for displaying a task period journal and the registry; wherein the system is configured to create a copy of an archived snapshot of the task period journal and push the task period journal from the copy of the archived snapshot to the display on the graphical user interface when the user inputs an instruction for the system to call the archived snapshot of the task period journal from the registry; the method further comprising: inputting a task in the task table and/or a note in the notepad; calling for the first archived snapshot entry of the task period journal from the registry to be displayed on the graphical user interface; creating a copy of the first archived snapshot entry of the task period journal; creating the second snapshot entry of the task period journal comprising the inputted task in the task table and/or the inputted note in the notepad; saving the task period journal in the registry as the second archived snapshot entry; and pushing the copy of the first archived snapshot entry of the task period journal to the graphical user interface for display, thereby replacing the task period journal comprising the inputted task in the task table and/or the inputted note in the notepad.

In various embodiments, a computer implemented method of customizing a Kanban board on a personal dashboard while maintaining a generic Kanban board on a team dashboard is provided. The method can comprise: providing a computer-implemented task management system for carrying out the method, the system, comprising: at least one computing device in operable communication with a network; a memory that stores computer-executable instructions; a processor in communication with the memory and configured to execute the computer-executable instructions, wherein the computer-executable instructions invoke one or more application program components, comprising: a Kanban board module configured to provide a Kanban board comprising one or more Kanban lanes and one or more Kanban cards in at least one of the one or more Kanban lanes, wherein each of the one or more Kanban cards represents a particular task, and each of the one or more Kanban cards is configured to receive a user inputted modification; and a display module configured to provide a graphical user interface for displaying the one or more Kanban cards on the Kanban board displayed on the personal dashboard and the team dashboard; wherein, when the one or more Kanban cards is displayed on the generic Kanban board of the team dashboard and accessible by a plurality of users, and a particular Kanban card is moved from a first Kanban lane to a second Kanban lane on the generic Kanban board, each user of the plurality of users, having an independent computing device for displaying the generic Kanban board on a graphical user interface, will see the one or more Kanban cards displayed in an identical position on the generic Kanban board before and after the particular Kanban card is moved; and wherein, when the one or more Kanban cards is displayed on the customized Kanban board of the personal dashboard, and the particular Kanban card is moved from the first Kanban lane to the second Kanban lane on the customized Kanban board displayed on the computing device of the first user, the particular Kanban card will not be moved on the Kanban board of the personal dashboard for each of the plurality of users other than the first user; the method further comprising; modifying a location of the particular Kanban card on the customized Kanban board on the personal dashboard from the first Kanban lane to the second Kanban lane, wherein the particular Kanban card on the generic Kanban board on the team dashboard remains in the first Kanban lane.

### BRIEF DESCRIPTION OF THE DRAWINGS

The features and advantages of the present disclosure will be more fully described in, or rendered obvious by the following detailed description of the preferred embodiments, which are to be considered together with the accompanying drawings wherein like numbers refer to like parts and further, wherein:

FIG. 1 illustrates a block diagram of a computer system and network infrastructure, in accordance with embodiments described herein;

FIG. 2 is a block diagram of the computing system and application program of FIG. 1;

FIG. 3 is a block diagram of the application program of FIG. 2;

FIG. 4 is a flow chart showing a customization and aggregation process, in accordance with embodiments described herein;

FIG. 5 is a flow chart showing a task period journal process, in accordance with embodiments described herein;

FIG. 6A illustrates a graphical user interface, in accordance with embodiments described herein;

FIG. 6B illustrates a graphical user interface associated with FIG. 6A;

FIG. 7 illustrates a graphical user interface of a workflow interface, in accordance with embodiments described herein;

FIG. 8 illustrates a graphical user interface of a task interface, according to some embodiments described herein;

FIG. 9 illustrates a graphical user interface of a matter interface, according to some embodiments described herein; and

FIG. 10 illustrates a graphical user interface of a note interface, according to some embodiments described herein.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### DETAILED DESCRIPTION

Reference will now be made in detail to the present preferred embodiment(s), and examples of which is/are illustrated in the accompanying drawings. Whenever possible, the same reference numerals will be used throughout the drawings to refer to the same or like parts. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, apparatus, and/or computer program product at any possible technical detail level of integration. A computer program product can include, among other things, a computer-readable storage medium having computer-readable program instructions thereon for causing a processor to carry out aspects of the present disclosure.

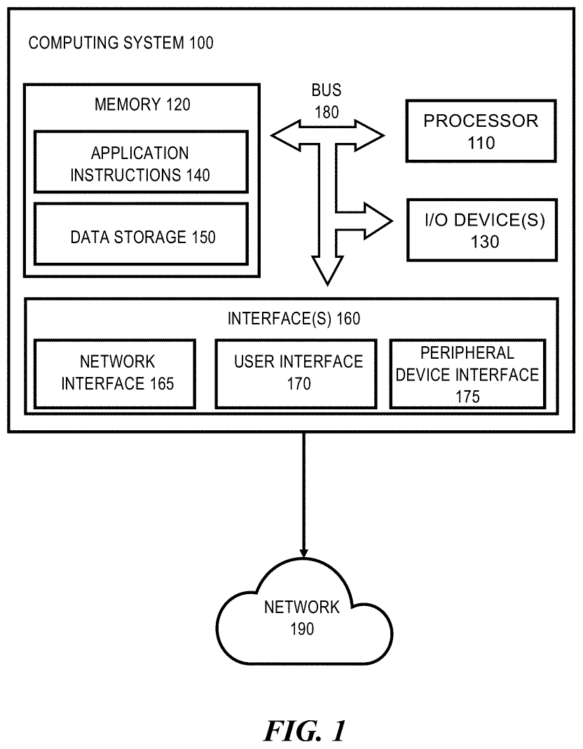

As shown in FIGS. 1-10, the embodiments described herein generally relate to a workflow and task management system that permits a user to customize the display of information on their user workspace, that automatically aggregates the data inputted from a plurality of the individual user workspaces to a centralized administrator workspace, and that provides a method for automatically saving task-related entries in a task period journal.

FIG. 1 illustrates a high-level example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units, and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithread execution capability, multi-core processors, multi-core processors with software multithread execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

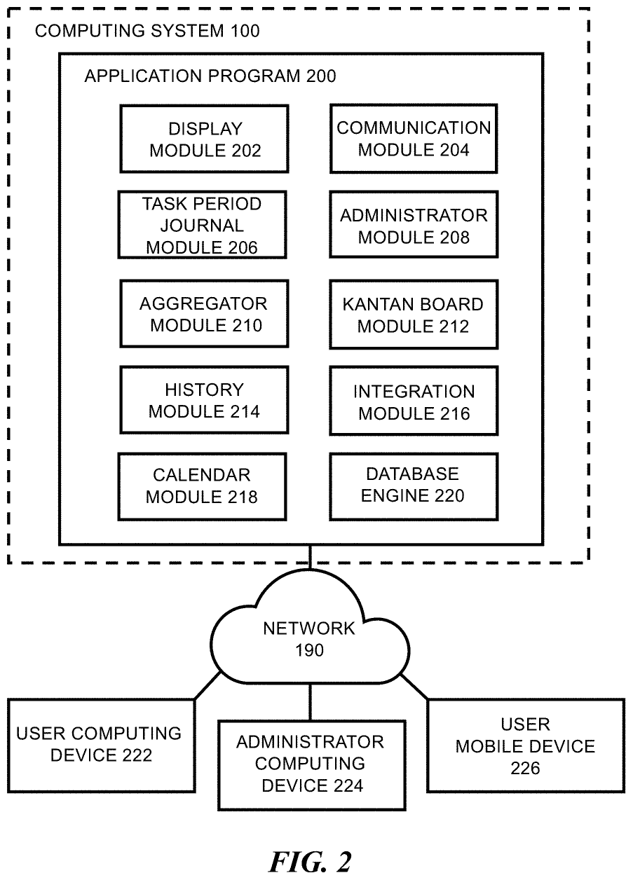

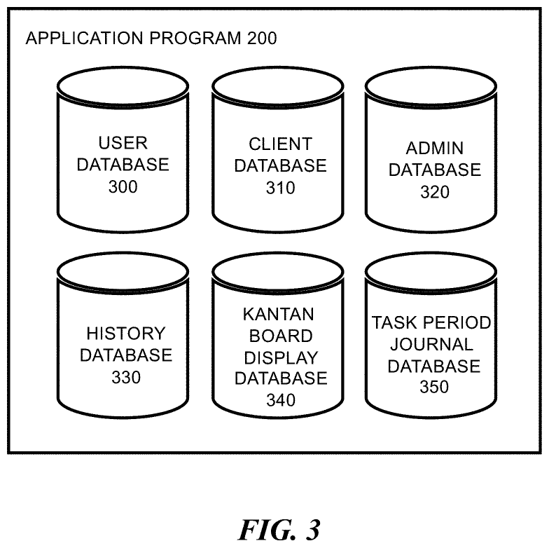

FIGS. 2 and 3 illustrate an example computer architecture for the application program 200 for the workflow and task management system described herein. FIG. 2 is a block diagram showing the module and engine components needed to perform the various specific tasks within the computer system 100. In particular, FIG. 2 shows the components of the application program 200, which comprises a plurality of modules and engines configured to provide: a system offering a personal dashboard and a team dashboard, each configured for displaying shared tasks, such that the display of the personal dashboard of tasks (e.g., a Kanban board) can be customized in a manner that is unique to an individual user without changing the corresponding display of the team dashboard of tasks; a system that retrieves data associated with the tasks on each of the individual computing devices of a plurality of users, aggregate the retrieved data, and push the aggregated data to each of the individual computing devices for display on the team dashboard and the personal dashboard; and a method for automatically saving user-entered and task-related notes to a task period journal such that archived journal entries can be later called, cloned, and reused for new tasks. FIG. 3 is a block diagram showing the one or more databases utilized by the various modules and engines.

In various embodiments, the application program 200 in FIG. 2 is accessible via the network 190 to one or more user computing device(s) 222, the administrator computing device 224, and/or one or more user mobile device(s) 226. In some embodiments, the administrator computing device 224 is configured, for example, to carry out any updates are required or to program any further implementations to the application program 200.

Referring to FIG. 2, the application program 200 comprises one or more modules having the necessary routines and data structures for performing specific tasks, and one or more engines configured to determine how the program manages and manipulates data. In some embodiments, the application program 200 comprises one or more components, such as a display module 202, a communication module 204, a task period journal module 206, an administrator module 208, an aggregator module 210, a Kanban board module 212, a history module 214, an integration module 216, a calendar module 218, and a database engine 220.

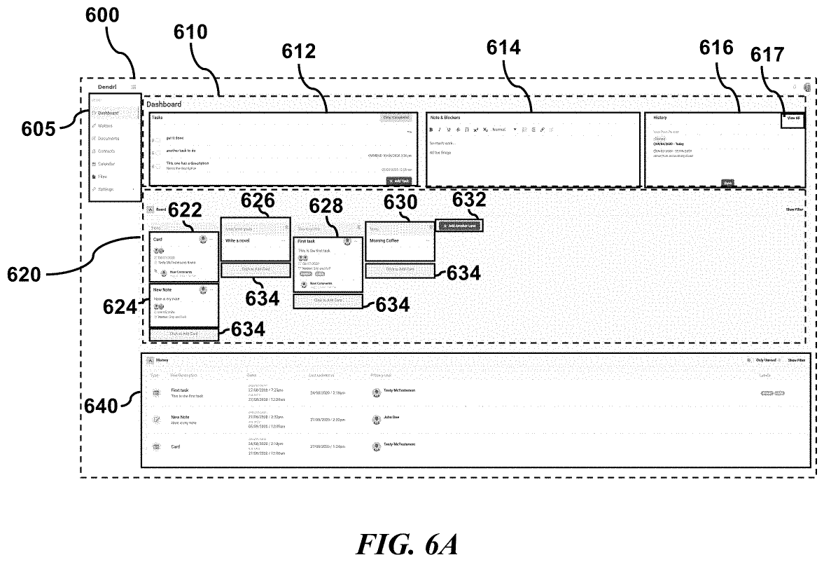

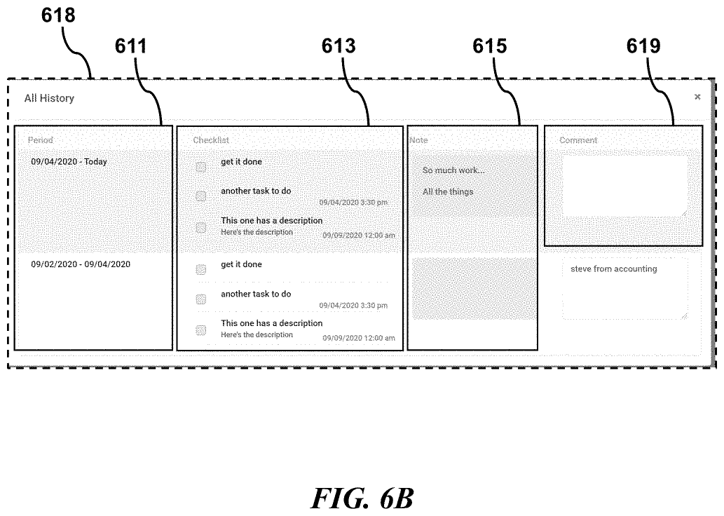

In some embodiments, the display module 202 is configured to display one or more graphic user interfaces and one or more administrator interfaces. In some embodiments, the display module 202 is configured to temporarily generate and display various pieces of information in response to one or more commands or operations. The various pieces of information or data generated and displayed may be transiently generated and displayed, and the displayed content in the display module 202 may be refreshed and replaced with different content upon the receipt of different commands or operations. In such embodiments, the various pieces of information generated and displayed in a display module 202 may not be persistently stored. Example user interfaces produced by the display module 202 are shown in FIGS. 6A-10.

In some embodiments, the communication module 204 is configured for receiving, processing, and transmitting a user command and/or one or more data streams. In such embodiments, the communication module 204 performs communication functions between one or more user computing device(s) 222, the administrator computing device 224, and/or one or more user mobile device(s) 226. In some embodiments, the communication module 204 is configured to allow one or more users of the system to communicate with one another. In some embodiments, the communications module 204 is configured to maintain one or more communication sessions with one or more user computing device(s) 222, the administrator computing device 224, and/or one or more user mobile device(s) 226. In some embodiments, the communication module 204 is configured to associate emails from an email system with a client, a matter, or a task and store the email communication in association with the task, client, or matter.

In some embodiments, the task period journal module 206 is configured to provide a task period journal 610 comprising one or more component(s). In some embodiments, the task period journal comprises a task table listing each of the tasks for the current task period, a notepad for the task period, and a registry having one or more saved “snapshots” for the task period. In some embodiments, for example, the task period journal module 206 is configured to save (manually or automatically) a snapshot of the task table and notepad to the registry, which is configured to display all saved snapshots for the particular task period.

In some embodiments, as shown in the user dashboard 600 in FIG. 6A, the task period journal 610 comprises a task table 612 listing each task/goal/project/item a user has inputted to the table for a predetermined task period. In some embodiments, the length of time for each task period is adjustable. In some embodiments, the task table 612 is configured to serve as a to-do list and allow a user to quickly input new to-do task entries, flip between different task entries, and track the progress of the user's various task entries. As shown in FIG. 6A, the task table 612 can include a task entry title, a description of the task entry, and a status for the task entry (e.g., incomplete, complete, overdue, etc.).

In some embodiments, the task period journal 610 comprises a notepad 614 configured to receive one or more instructions, reminders, noteworthy items, or any other content that is typically inputted on a notepad by a user. In such embodiments, the notepad 614 can be configured with some features typically associated with word processing (e.g., choice of font).

In some embodiments, the task period journal 610 comprises a registry 616 containing each snapshot saved for the currently displayed task period. As shown in FIG. 6A, the registry 616 provides one or more snapshot entries for each task period, the snapshot including both the tasks in the state when the user saved them (e.g., incomplete, complete, etc.) and the notes corresponding to the saved task period. In some embodiments, the entries in the registry 616 cannot be deleted.

In some embodiments, the registry 616 comprises a functional button that, when selected, will call up a list of all saved snapshots and display the list in order by the date the snapshot was saved in the task period history. For example, in FIG. 6A, the registry 616 comprises a “View All” button that, when selected by the user, causes the system to display a new user interface 618, as shown in FIG. 6B. In some embodiments, the interface 618 comprises a snapshot column 611, a snapshot task checklist column 613, a snapshot notes column 615, and a snapshot comment column 619. In some embodiments, the content in the snapshot column 611, snapshot task checklist column 613, and snapshot notes column 615 cannot be edited or deleted. In such embodiments, the snapshot comment column 619 can be utilized by a user to input comments about the particular snapshot. For example, if a user is forced to delay the completion of a task, the user can input a comment explaining why the delay occurred for future reference.

In some embodiments, the functions of the registry 616 can be coupled to those of the task table 612. For example, in some embodiments, a user can indicate to the system their desire to call for a saved task period snapshot to be loaded onto the user task period journal 610. In such an example, the selected task period will replace the current tasks and notes displayed in the task period journal 610. In such embodiments, this function causes the current tasks and notes displayed in the task period journal 610 to be automatically saved as its own snapshot entry in the registry 616. In some embodiments, each snapshot is saved in the registry 616 in an additive rather than destructive process.

In some embodiments, the system will not allow the user to edit a task period saved in the registry 616. Instead, in such embodiments, when the user wants to use the saved task period on their current dashboard, the system creates a copy of the saved task period in the task period journal 610 by cloning the previously saved snapshot. The cloned task period journal 610 can be edited by the user. In some embodiments, the task period journal module 206 is configured to allow a user to switch between a currently displayed task period and one or more previously saved task period snapshots. The task snapshots can refer to a group of related items on the task to-do list, whether they are related to a personal task or a team task.

For example, consider a hypothetical user having four client calls and several marketing tasks she wants to accomplish. The user creates a task checklist listing the four calls (adding description and dates as necessary). But when the user is trying to make the client calls, a colleague interrupts her with an emergency. At this point, the user can input a note using the notepad 614 stating why she was interrupted, and the user can then open her marketing tasks from the registry 616 before requesting the system to “save current and replace,” which will cause the note indicating why she failed to complete her client call tasks and the current status of those tasks to be saved as a snapshot entry in the registry 616. Her marketing tasks will now be shown in her user interface. In this example, the user can accomplish her marketing tasks, input a message to the notepad 614 (e.g., how the emergency was resolved), and return to her client call task list entry (the previously saved snapshot). In some embodiments, the “save current and replace” function provided by the task period journal module 206 is configured to allow the user to start where they left off before the interruption, and her accomplishments related to the marketing task list recorded forever. In some embodiments, the user can recall a snapshot registry entry, add notes to the snapshot using the comments function 619, which will show as a “description” of the period but can also help the user make global observations of her productivity and blockers over time.

In some embodiments, the Kanban board module 212 is configured to provide a Kanban board on one or more graphical user interface(s) (e.g., personal or team dashboards). In some embodiments, the Kanban board comprises one or more Kanban lane(s) having one or more Kanban card(s) in each Kanban lane. In this context, a Kanban card is an element of the interface that represents a particular task (e.g., a project, such as a trial or hearing in a civil litigation case) and allows a user to input comments or notes thereto. In some embodiments, the Kanban card is configured to associate the information inputted and contained therein with a particular project (such as a client or matter) and to permit the database to accurately store information and transmit information to the server when requested by the user. Each Kanban card is configured to be optionally shared by a plurality of users, and each Kanban card is configured to accept a request from an authorized user to initiate an invitation for other users to optionally have access to the Kanban card. In some embodiments, when a particular Kanban card is shared with a group of users and is modified by one user of the group, then each of the other users in the group will see the information that was inputted on the Kanban card. An example Kanban board 620 is shown in FIG. 6A.

In some embodiments, a Kanban board can be included on one or more graphical user interfaces. For example, a Kanban board can be included in a project interface, a personal dashboard interface, and/or a team dashboard interface. In such embodiments, specific restrictions (e.g., user access, user modifications allowed) can be independently attached to one or more of the Kanban boards. In some embodiments, a Kanban board contains each task the user has created or has been assigned. In some embodiments, a plurality of users can be assigned to a particular task and each user will have their own Kanban board for the task on their personal user dashboard.

A personal dashboard interface 600 is shown in FIG. 6A, which includes the Kanban board 620, along with the user's task period journal 610. In such embodiments, for example, the Kanban board 620 comprises a plurality of Kanban cards 622, 624, 626, 628, and 630. The Kanban cards 622 and 624 are in a first Kanban lane (optionally identified as an “inbox” lane), the Kanban card 626 is in a second Kanban lane, the Kanban card 628 is in a third Kanban lane, and the Kanban card 630 is in a fourth Kanban lane (optionally identified as “done” lane). Although this example is shown with five Kanban cards and four Kanban lanes, any suitable number of cards and lanes is contemplated. In some embodiments, the Kanban board 620 comprises a plurality of Kanban cards, or a specified number of Kanban cards ranging from 1 to 100, from 1 to 50, from 2 to 30, from 2 to 20, etc. Similarly, the Kanban board 620 comprises a plurality of Kanban lanes, or a number of Kanban lanes ranging from 1 to 100, from 1 to 50, from 1 to 20, from 1 to 10, from 2 to 15, etc. In any of said ranges, the endpoints are included, combinable, and interchangeable, and any intermediate numbers may serve as an endpoint to provide a subrange or new range.

In some embodiments, the Kanban board 620 comprises a lane button 632 for creating a new Kanban lane, and a card button 634 for creating a new Kanban card in an existing lane. In some embodiments, the Kanban board 620 is configured to allow a user can drag a Kanban card to another position on the Kanban board 620, including to an existing Kanban lane or to create a new Kanban lane. During use, if a user drags a Kanban card to a new location, such as a new lane, that movement does not affect the display of the Kanban board on another user's computing device. Accordingly, in such embodiments, when there is a plurality of users assigned to a particular team project, the Kanban board on each of the user devices 222 will be provided with the same information (e.g., Kanban cards). In such embodiments, how a specific user organizes their Kanban board has no effect how another user's Kanban board is organized.

In some embodiments, the positioning and placement of a newly assigned Kanban card can be specified. For example, a default setting can arrange for a newly assigned card to be placed in the user's “inbox” Kanban lane. This will include any card from any matter or any team board the user is assigned. In some embodiments, the personal user dashboard 600 interface allows each user to create whatever lane or organizational method makes sense for them. In such embodiments, the Kanban card and data are cloned and synced so the internal content (notes, comments, labels, assignees, etc.) is synced for all users while the position and status (i.e., the Kanban lane the card is on) can be altered for each user status without impacting any other user. In some embodiments, any user can manually update the status of a task on the matter board using, for example, a dropdown menu listing options for changing the status, without having to navigate back to the matter. Such a change will update the “matter status” for all users and trigger any needed automations. For example, if a user finishes a team task and updates the status of the task to “done,” the system will move the Kanban card to the “done” column in the matter Kanban board. In some embodiments, a user can also archive a task on the user dashboard to remove it from their view on the interface. Archived tasks can be toggled to be viewed with a filter control and a user can optionally select “archive in place” so the card maintains its position and lane when archived. This feature is useful when a task is prematurely considered unnecessary, but then understood to be necessary after all. In such embodiments, a user can view archived tasks, unarchive a specific task, and begin working on the task where they previously stopped.

In some embodiments, a user can create one or more “personal” task cards on their user dashboard 600. The personal Kanban cards can be marked personal and therefore not be associated with any particular project. In some embodiments, a personal Kanban card can be assigned to and/or shared with other users.

In some embodiments, the Kanban board 620 on the user dashboard 600 is configured to be customized by a user on the one or more user computing devices 222. In such embodiments, the Kanban board module 212 is configured to apply or modify the user interface settings on the user computing devices 222, including the layout of Kanban lanes and Kanban cards. As such, the Kanban board module 212 permits a user to organize and display the projects in a manner that is most useful to that user.

In some embodiments, a team dashboard interface can be generated by creating a team of users. The team can be closed, meaning that inclusion in the team requires an invitation (e.g., attorneys only) or open to any organization user. In some embodiments, a Kanban card can be assigned to one or more existing teams. In some embodiments, a team dashboard resembles a personal user dashboard 600 except that it is shared by all team users. Thus, all users viewing a team dashboard will see the same snapshots in their task period journal 610, and the same Kanban cards in the same position on their Kanban lanes. In some embodiments, this feature is useful for grouping tasks together by the type of work involved rather than by the general type of task. For example, an injury law firm that needs to request medical records for many clients may create a team for “records requests” and set up a lane for commonly used providers or record copy companies. In this example, whichever users share that task can make a single call to a provider and see at a glance the several requests that need to be followed up on across multiple projects.

In some embodiments, a user can create a “team” task (Kanban card) on the team dashboard. The team task can be marked as being owned by the team and not associated with a specific project. In some embodiments, the team task is assigned to and/or shared with one or more users, similar to other Kanban cards. In some embodiments, a Kanban card can be re-assigned from a personal dashboard to a team dashboard or a project dashboard, or vice versa, and a Kanban card can also be assigned to a different project. This versatility allows a team Kanban board to be created with many Kanban cards very quickly using templates and/or checklist groups. In some embodiments, the re-assignment function solves the problem when multiple projects are open for a single client because information such as phone messages and other cards that might need to be seen by different team members can be “missed” if only recorded in a single project.

With respect to a project board interface, the Kanban board module 212 will provide a project board that is displayed the same way for each user. In such embodiments, the lanes, cards, and their respective positions will be displayed the same way for any user viewing the project. In some embodiments, the application program allows a host organization to automate certain actions, such as when a Kanban card is moved from one Kanban lane to the next Kanban lane. For example, when a card is moved from a lane designated as “projects in progress” to “done,” the system will automatically create a new Kanban card having a name that is consistent with the next step in the project and assign an appropriate deadline, if necessary. In such embodiments, the project board must include preexisting Kanban lanes available and such lanes must be configured with the required functionality.

In some embodiments, the registry 616 in a project board will show all of the tasks (Kanban cards) in the task table 612. The task table can also integrate any other data referenced (e.g., notes, documents, calendar entries) so that tasks and information can be filtered, labeled, sorted, or addressed in a single table view. In some embodiments, the task table 612 can be exported as a spreadsheet, such as a comma separated values file (csv), which allows users to prepare invoices, archive a project history, and/or take other actions. These features improve on existing technologies, which almost universally separate content into tabs (e.g., for documents, time entries, messages, and more, mimicking a traditional paper file). In some embodiments, the application program 200 allows a user to see the entire history of a project in a single view and/or allows the user to label and/or sort mixed elements (for example, using a label called “trial preparation” could be used to tag the date of other events, such as client preparation, organization of documents needed for trial, tasks that need to be completed, and important notes or memoranda. In some embodiments, a filter can be used to see only the elements associated with the label, regardless of what they are, and the user can export those elements to a simple spreadsheet list for further organization.

In some embodiments, the administrator module 208 is configured to allow a user or administrative user to select permissions for each user having access to the application program 200. For example, an administrative user may permit only a specific, preselected user to create tasks, assign tasks, access task information, and/or update tasks within the system.

In some embodiments, the aggregator module 210 is configured to collect and aggregate the data located on one or more user commuting device(s) 222. In some embodiments, one or more users will receive an identical Kanban card. For example, if three users are each included on the same team for a specific project, an administrator or a user can create a Kanban card and define which users should have access to that card. In such embodiments, once a Kanban card is created, it is pushed to each of the users assigned to the project. When each user having access to the same card opens the Kanban card, the features therein will be displayed in their form as created. Each user can add a comment or note to the Kanban card on their user computing device 222. The aggregator module 210 is configured to retrieve the data on each user computing device 222 for each Kanban card shared between two or more users, and aggregate the data therein (e.g., comments from the different users).

In some embodiments, the history module 214 is configured to provide a history table 640. In such embodiments, the history table 640 comprises each of the projects a user has interacted on in the application program 200. For example, in some embodiments, the history table 640 includes each task, which is duplicated from the Kanban board 620, any user-entered notes, memorandums, or other non-actionable information, documents, and calendar entries. The history table 640 is specific to each user computing device 222. In some embodiments, the user can comment on any of the entries in the history table 640, or modify a setting associated with an entry (e.g., urgent, complete, etc.). In some embodiments, the history table 640 is configured to display a time and/or date stamp for the creation of each entry and for the last modification made to each entry.

In some embodiments, the integration module 216 is configured to allow a user to sync data from the user computing device 222 to a third-party software. For example, in some embodiments, the integration module 216 allows a user to sync a component from the application program 200, such as a calendar entry or contact, with the calendar or contacts provided by another software, such as Google, Yahoo, Hotmail, Microsoft Outlook, etc. In some embodiments, the integration module 216 is configured to automatically sync with third-party software. In some embodiments, the integration module 216 is configured to allow a user to sync data from the user computing device 222 to a user mobile device 226. For example, if a user accesses the application program 200 using a web application on the user's computing device 222, the integration module 216 is configured to facilitate communication (e.g., data transfer) between the user's computing device 222 and the user's mobile device 226, which uses a mobile application to access the application program 200.

In some embodiments, the calendar module 218 is configured to be populate dates and times associated with one or more projects, such as the data on a Kanban card for a specific project. In some embodiments, the calendar module 218 is configured to pull/receive start dates, due dates, and other information associated with a specific project (e.g., a client or matter) and display the information on the calendar interface accessible from the application program. In some embodiments, the calendar module 218 is configured to automatically pull/receive data from another component in the application program 200. For example, FIG. 6A shows a menu 605 comprising one or more alternative components offered, including a calendar. In such embodiments, the calendar module 218 is configured to populate the application calendar with any dates extracted from a Kanban card. In such embodiments, the data population can be automatically carried out by the system or initiated by the user.

In some embodiments, a database engine 220 is configured to facilitate the storage, management, and retrieval of data to and from one or more storage mediums, such as the one or more internal databases 300, 310, 320, 330, 340, and 350. In some embodiments, the database engine 220 is coupled to an external storage system. In some embodiments, the database engine 220 is configured to apply changes to one or more databases. In some embodiments, the database engine 220 comprises a search engine component for searching through thousands of data sources stored in different locations.

Referring to FIG. 3, in some embodiments, the system comprises a database infrastructure that is configured to store a plurality of information related to clients, tasks, and additional details related to the professional practice. The databases store a plurality of tasks, events, media, permissions, automation rules, client information (e.g., contact information and client personal data), documents, comments, task statuses, matter statuses, automations, notes, roles, contacts, templates, actions, and associated information thereof. The database is in communication with an application program 200, which comprises a plurality of modules to perform the various tasks performed by the system and described hereinabove.

In some embodiments, for example, the one or more databases includes a user database 300, a client database 310, an administrator database 320, a history database 330, a Kanban board display database 340, and a task period journal database 350.

In some embodiments, the user database 300 is configured to store data related to users authorized to use a user computing device 222 and access services provided by the system and application program 200. In some embodiments, the user database 300 stores usernames, login information, user profile information, as well as any other information supplied or inputted by a user, such as information related to personal accounts that may be integrated into the system (e.g., personal third-party email, calendar, or social media information).

In some embodiments, the client database 310 is configured to store data related to clients of the professional practice, such as contacts, contact information, and documents and data files associated with specific projects for the clients. In some embodiments, the client database 310 is configured to store data related to a specific project identified on a Kanban card, including the information for the client the specific project has been created for.

In some embodiments, the administrator (“admin”) database 320 is configured to store data related to the system preferences or default settings established by a system administrator. In such embodiments, the admin database 320 stores permissions for users within the network, etc. In some embodiments, the admin database 320 stores software libraries, application programming interface (API) software, or other software that may be useful on the application program 200 (e.g., to communicate with third-party software).

In some embodiments, the history database 330 is configured to store data related to the task history 616 and/or project history 640 on each user computing device 222. For example, any tasks entered and saved in the task period journal 610 are duplicated in the database and are retrievable in the form of a table.

In some embodiments, the Kanban board display database 340 is configured to store data related to the Kanban boards 620 on each of the user or administrator computing devices 222, 224. In some embodiments, the Kanban board display database 340 is configured to store the data on each of the individual user computing devices and the aggregated data associated with the individual user computing devices. In some embodiments, the Kanban board display database 340 is configured to store each Kanban card included on each user computing device.

In some embodiments, the task journal database 350 is configured to store data related to the task period journal 610 on each user's computing device. In such embodiments, the data associated with the task table 612, the notepad 614, and the registry 616 on each user computing device 222, the administrator computing device 224, and each mobile computing device 226.

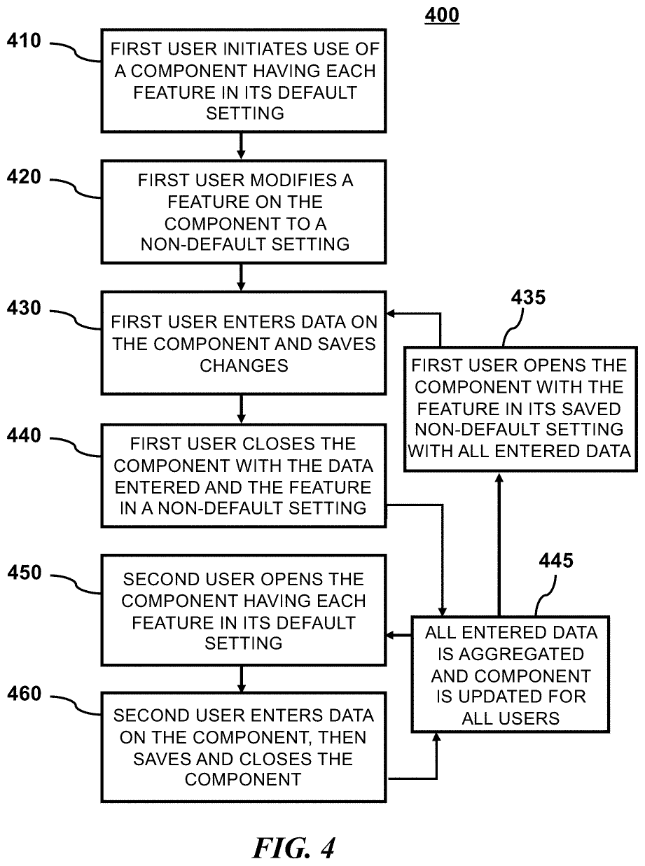

FIG. 4 illustrates a process 400 carried out by the system described herein. In particular, the process 400 involves the modification of a system component (e.g., a Kanban board or Kanban card) that is shared among a plurality of users working as a collaborative team, as well as the aggregation of information inputted on one or more individual workstations (e.g., a Kanban card on one or more personal dashboards) and distribution of the information retrieved from the aggregation to each of the plurality of users working in collaboration with the individual who inputted the information (e.g., on a Kanban card on each personal dashboard and team dashboard for the project).

In step 410, a first user initiates the use of a component on an individual user computing device 222. In some embodiments, the component is a Kanban card that has been populated on a Kanban board that is displayed on a personal dashboard. When the user opens the component for the first time, all features associated with the component are in their default form. For example, each Kanban card is positioned in a Kanban lane as determined by the user who created the task in the system. In such embodiments, the initial placement of the Kanban card on the Kanban board is the default position for the Kanban card.

In step 420, the user modifies a feature of the component to a non-default setting. For example, the user modifies the location of the Kanban card on their Kanban board (e.g., the user moves the Kanban card to a different Kanban lane). In step 430, the user enters data on the component while it is in a non-default setting and saves the changes. For example, the user inputs an update in the comment portion of a Kanban card.

In step 440, the user closes the component having the modified feature in its non-default setting. In step 445, the data inputted by the user to the component is retrieved by the aggregator module 210.

In step 450, a different user opens the component on their computing device 224, e.g., in their personal dashboard, and the component opens with each feature in its default setting. In such embodiments, the feature includes any data previously entered by the other user in step 430 because the aggregator module 210 has retrieved it and updated the component for all users. In step 460, the different user inputs data to the component, saves the changes, and closes the component.

In step 435, when the first user opens the component again, the feature that was modified to a non-default setting will be displayed in the modified setting on the user's personal dashboard. In addition, the component will include all data that has been inputted by any user having access to the component (e.g., those who have been assigned to collaborative team) because the data is retrieved by the aggregator module in the intermediate step 445. Further, when the first user opens the component again in step 435, the component and its features will appear on the user's personal dashboard in the non-default setting that was previously saved.

In some embodiments of the process 400, one or more users can collaborate on the same project or task, such as a task associated with a specific Kanban card; each of the users can modify the default settings as to how the Kanban card is positioned or otherwise used on their Kanban board; each of the users can enter data to the Kanban card; the system will aggregate the data entered from each user so all users can see all of the data entered by any user; and the data can be viewed using the user's specifically modified default settings without effecting the settings (default or modified) for the component (Kanban card) on the other users personal dashboard.

The process 400 provides several advantages. In some embodiments, a plurality of users collaborating on the same task will each have a personal dashboard displaying a Kanban board that allows the Kanban cards and/or Kanban lanes to be modified as each user prefers. The plurality of users will also be assigned and have access to a team dashboard that displays a Kanban board, which is not configured for customization; i.e., the Kanban board on the team dashboard is displayed the same on each of the user devices. The process 400 also allows each user collaborating on the task to input comments or other information (e.g., documents, links, etc.), and the information entered by each user is retrieved by the aggregator module 210, thereby providing each user with a real-time status of the task.

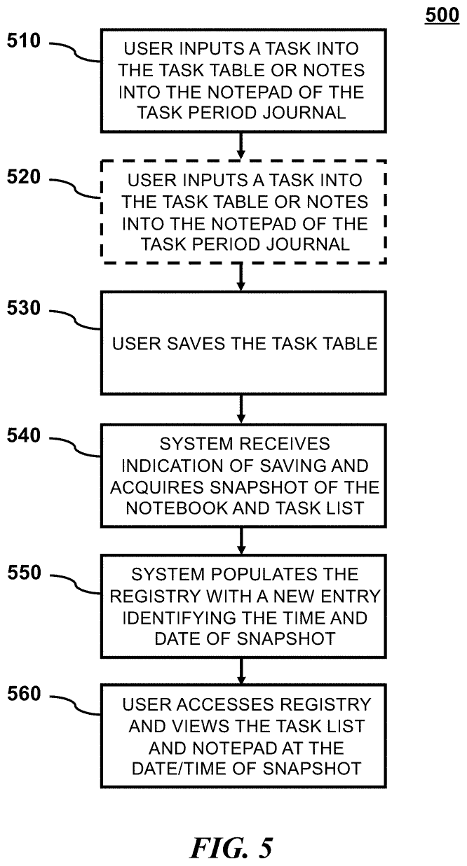

FIG. 5 illustrates a process 500 carried out by the system described herein. In particular, the process 500 involves the automatic saving and archiving of entries into the task period journal 610. In some embodiments, the task period journal comprises a task table 612, a notepad 614, and a registry 616. the task period journal 610 comprises a task table 612 listing each task/goal/item a user has entered to the table, the task period journal 610 comprises a notepad 614 where a user can enter content that is typically entered on a notepad, and a registry 616 containing each task entered and saved on the task table 612.

In some embodiments, the process 500 is initiated in step 510 when a user inputs a new task to the task table 612 and/or inputs notes into the notepad 614. Optionally, as indicated by the broken lines in step 520, the user inputs a new task to the task table 612 and/or inputs notes into the notepad 614. In such embodiments, the user can input only a task into the task table 612 in step 510 and only a note into the notepad 614 in step 520; or, the user can input only a note into the notepad 614 in step 510 and only a task into the task table 612 in step 520; or, the user can input both a task into the task table 612 and a note into the notepad 614 in step 510 and nothing in step 520; or the user can input both a task into the task table 612 and a note into the notepad 614 in step 510 and another note into the notepad in step 520; or, any combination thereof.

In step 530, the user saves the task period journal 610. Once the system receives an indication the data in the task period journal 610 has been saved, in step 540, a snapshot of the task table 612 and notepad 614 is acquired, and a copy of the snapshot is saved in the registry 616. In some embodiments, the snapshot is also saved in the task period journal database 350 and/or the history database 330.

In step 550, the system populates the registry 616 with the snapshot of the task period journal 610. In step 560, the user accesses the registry 616 and can view the snapshot of the task period journal 610 previously saved and any other prior snapshots because entries in the registry 616 cannot be deleted. In some embodiments, the user selects a saved snapshot and that indicates to the system to save the task period journal 610 currently displayed in the dashboard to the registry 610, and the system clones a copy of the selected snapshot and pushes it to the dashboard, thereby replacing the previously used task period journal 610.

The process 500 provides several advantages. In some embodiments, the user has access to any previously saved task period journal. As such, any saved snapshot can be used as a template for a new task period journal. In some embodiments, a user can create a variety of task period journals and load a particular snapshot onto the dashboard at a predetermined time. For example, if a user has a routine in which the same tasks are carried out on each Monday, or each Friday, then a saved task period journal for the particular day can be created, saved, and reused each week. In some embodiments, a saved task period journal (i.e., snapshot) cannot be modified by the user. However, the system provides a comment function which allows the user to input additional notes related to a specific task period journal.

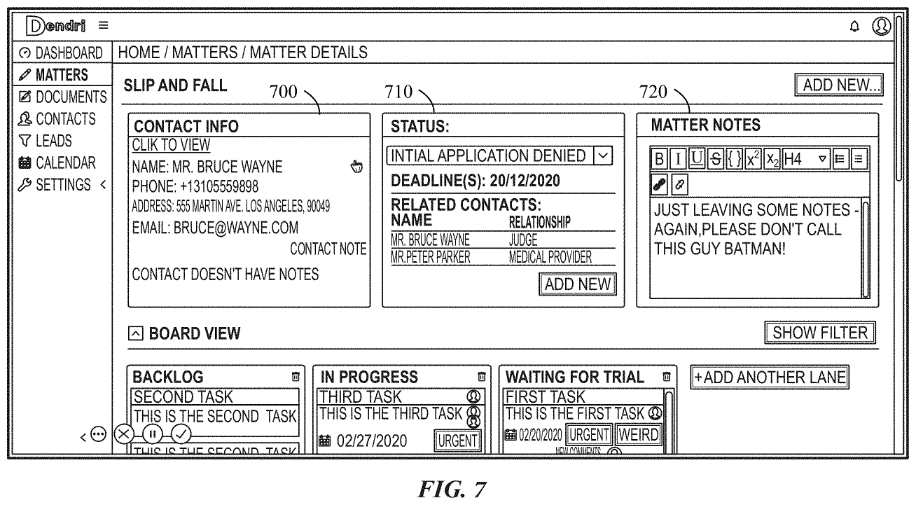

FIG. 7 shows a graphical user interface of a dashboard interface 700 that includes a plurality of selectable tabs including a “documents” tab, a “contacts” tab, a “leads” tab, a “calendar” tab, and a “settings” tab. In some embodiments, the graphical user interface 700 allows a user to view all information related to a matter on a single screen without referencing external software or computerized systems. Specifically, FIG. 7 illustrates the selection of the “matters” tab, whereby the matter name is provided in addition to the contact information 705 associated with the matter, the status 710 of the matter, and matter notes 720 related to the matter. The contact information 705 contains the client name, contact information, and associated notes thereof. The status 710 indicates a status of the matter which may include associated deadlines, related contacts (e.g., judges, outside council, opposing council, or other persons associated with the matter), and a status indicator. The matter notes 720 allows the user to input notes for the matter that are stored and provided in the status 710 portion of the matter interface. In some embodiments, the matter interface includes one or more interfaces to enter backlogs, project details, and/or the status thereof. The matter interface allows for the customization of the configuration and display of information on the user's screen without changing the configuration and display of the information on other users' screens who may be associated with the matter.

In some embodiments, a first user can alter information on at least one interface without altering the display of the information on the display interacted with by a second user. Further, the first user can alter information or the display thereof without changing the display of information on a matter interface. Although a first user and a second user are provided here as an example, the disclosure is not limited to two users. Therefore, additional users (e.g., third, fourth, fifth, etc.) may also interact with the same interface.

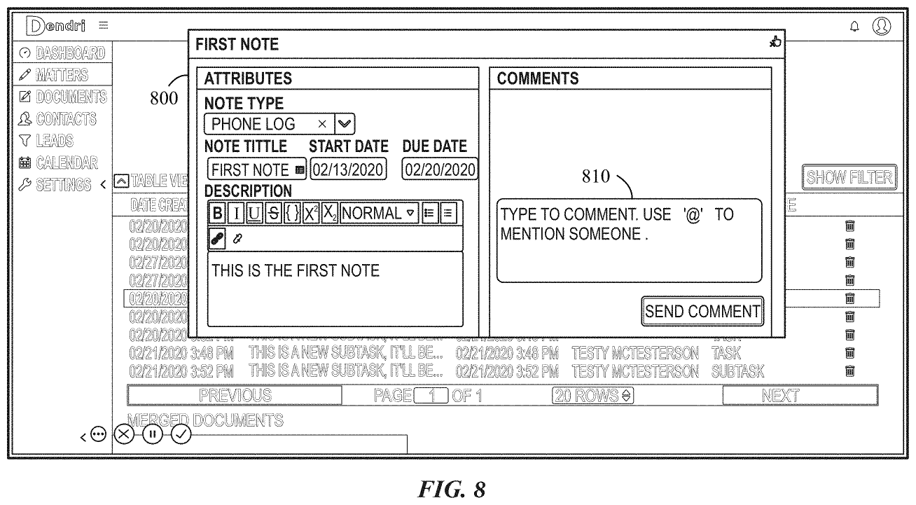

FIG. 8 shows a graphical user interface of a note interface 800 that allows users to add information for a matter, client, task, or the like. For example, in some embodiments, the note interface 800 includes a note type, title, start date, deadlines, and/or description of a matter. In some embodiments, a user can input comments in a comment generator 810. In some embodiments, the comment generator 810 associates the comment created by the user with the matter, client, or project. The comment is stored in the database and may be accessed when viewing information related to the matter, client, or project.

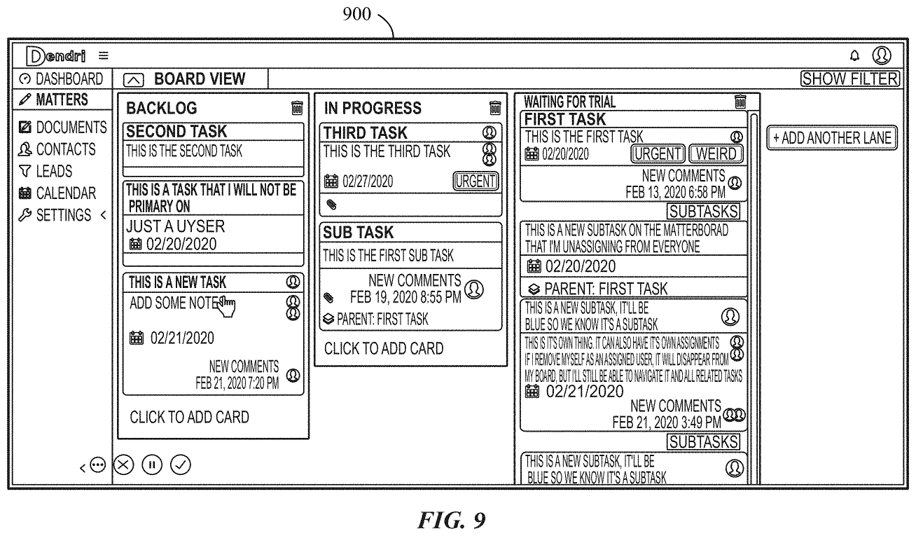

FIG. 9 shows a graphical user interface of the workflow interface 900, which comprises information related to each matter. The workflow interface 900 permits a user to create a personalized and customized interface for viewing details related to the workflow. For example, in some embodiments, the user can select an option to “add another lane,” which provides the user with the ability to customize the lane name, such as a “backlog” lane containing backlogged tasks. In another example, a user may create an “in progress” lane which illustrates tasks which are currently in progress. In some embodiments, the workflow interface 900 allows a user to select the information they want to view in a single interface for one or more workflows.

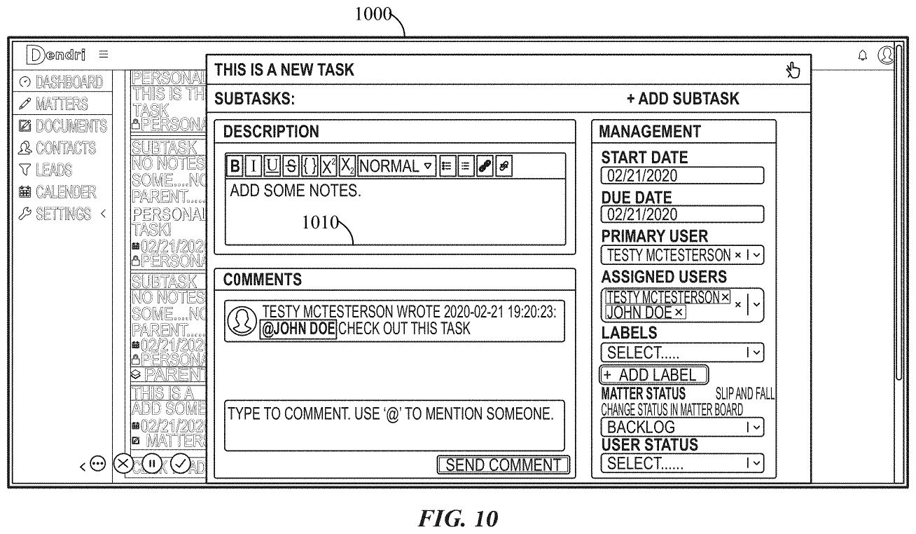

FIG. 10 shows a graphical user interface of a task interface 1000, which allows a user to input information related to one or more tasks. In some embodiments, the task interface 1000 comprises a description input 1010, wherein the user provides information related to the task. The description may include comments, task descriptions, or other information that may be input and accessed. In some embodiments, the user can add a subtask for one or more tasks input on the task interface 1000. Each task may be provided with task information including, for example, a start date, due date, user, assigned user, labels, matter status, and user status.

The system described herein offers individual user Kanban board customization and the automatic aggregation of the data from a plurality of the individual user dashboards to a shared dashboard. Further, the system provides a method for automatically saving a snapshot of a task period journal when an archived snapshot of the task period journal is called by the system for display.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the flowchart and block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

I claim:

1. A computer-implemented task management system, comprising:
at least one computing device in operable communication with a network;
a memory that stores computer-executable instructions;
a processor in communication with the memory and configured to execute the computer-executable instructions, wherein the computer-executable instructions invoke one or more application program components, comprising:
a task period journal module configured to provide a task period journal comprising a task table listing one or more tasks a user or team of users is assigned to complete and a notepad for documenting remarks about the one or more tasks, wherein one or more snapshots of the task period journal is archivable in a registry comprising each of the one or more snapshots related to the one or more tasks; and
a display module configured to provide a graphical user interface for displaying a task period journal and the registry;
wherein the system is configured to create a copy of an archived snapshot and push the task period journal from the copy of the archived snapshot to the display on the graphical user interface when the user inputs an instruction for the system to call the archived snapshot of the task period journal from the registry.

2. The system of claim 1, wherein the task table and the notepad in the archived snapshot of the task period journal are not editable by the user when displayed from the registry on the graphical user interface, and wherein the task table and the notepad in the copy of the archived snapshot are editable by the user when displayed from a user dashboard on the graphical user interface.

3. The system of claim 1, wherein the task period journal from the copy of the archived snapshot replaces the task period journal displayed on the graphical user interface when the system receives the instruction from the user input.

4. The system of claim 3, wherein the task period journal displayed on the graphical user interface when the system receives the instruction from the user input is automatically saved as a new snapshot in the registry when it is replaced by the task period journal from the copy of the archived snapshot.

5. The system of claim 4, wherein the saving the new snapshot is an additive process and not a destructive process.

6. The system of claim 2, wherein the registry comprises each task period journal entry saved from the user dashboard, and a comment pad for each of the saved task period journal entries, the comment pad configured to receive comments inputted from the user.

7. The system of claim 1, further comprising a history module configured to provide a history table listing each task the user has interacted with in the application program.

8. A computer-implemented task management system, comprising:
at least one computing device in operable communication with a network;
a memory that stores computer-executable instructions;
a processor in communication with the memory and configured to execute the computer-executable instructions, wherein the computer-executable instructions invoke one or more application program components, comprising:
a Kanban board module configured to provide a Kanban board comprising one or more Kanban lanes and one or more Kanban cards in at least one of the one or more Kanban lanes, wherein each of the one or more Kanban cards represents a particular task, and each of the one or more Kanban cards is configured to receive a user inputted modification; and
a display module configured to provide a graphical user interface for displaying the one or more Kanban cards on the Kanban board displayed on a personal dashboard, a team dashboard, or a project dashboard;
wherein, when the one or more Kanban cards is displayed on the Kanban board of the team dashboard and accessible by a plurality of users, and a particular Kanban card is moved from a first Kanban lane to a second Kanban lane on the Kanban board, each user of the plurality of users, having an independent computing device for displaying the Kanban board on a graphical user interface, will see the one or more Kanban cards displayed in an identical position on the Kanban board before and after the particular Kanban card is moved; and
wherein, when the one or more Kanban cards is displayed on the Kanban board of the personal dashboard, and the particular Kanban card is moved from the first Kanban lane to the second Kanban lane on the Kanban board displayed on the computing device of the first user, the particular Kanban card will not be moved on the Kanban board of the personal dashboard for each of the plurality of users other than the first user.

9. The system of claim 8, wherein the one or more Kanban cards on the team dashboard can be re-assigned to the personal dashboard, and the one or more Kanban cards on the personal dashboard can be re-assigned to the team dashboard.

10. The system of claim 8, further comprising an aggregator module configured to retrieve data associated with the one or more Kanban cards on each of the independent computing devices of the plurality of users, aggregate the retrieved data, and push the aggregated data to the graphical user interface of each of the independent computing devices for display on the team dashboard and the personal dashboard.

11. The system of claim 8, wherein the first Kanban lane is designated with a first descriptive label and the second Kanban lane is designated with a second descriptive label, and each of the one or more Kanban cards in the first Kanban lane includes a status identifier that is consistent with the label of the first Kanban lane; and
wherein the system will automatically convert the first status identifier displayed on a first Kanban card to a second status identifier that is consistent with the second Kanban lane when the first Kanban card is moved from the first Kanban lane to the second Kanban lane.

12. The system of claim 11, further comprising a communication module configured to facilitate communications;
wherein the system automatically creates a document supplying information associated with the conversion of the first status identifier to the second status identifier, and transmits a communication comprising the document.

12. The system of claim 8, wherein the system is configured to display an archived Kanban card on an archive graphical user interface, receive an input to reclassify the Kanban card as unarchived, and redisplay the unarchived Kanban card on the Kanban board.

13. The system of claim 8, wherein the system is configured to automatically display a first Kanban card on the first Kanban lane of the Kanban board displayed on the personal dashboard of a user when the first Kanban card is assigned to a user.

14. The method of claim 8, further comprising a history module configured to provide a history table listing each task the user has interacted with in the application program.

15. The system of claim 8, further comprising a task period journal module configured to provide a task period journal comprising a task table listing one or more tasks the plurality of users is assigned to complete and a notepad for documenting remarks about the one or more tasks, wherein one or more snapshots of the task period journal is archivable in a registry comprising each of the one or more snapshots related to the one or more tasks;
wherein the system is configured to create a copy of an archived snapshot and push the task period journal from the copy of the archived snapshot to the display on the graphical user interface when the user inputs an instruction for the system to call the archived snapshot of the task period journal from the registry.

16. A computer implemented method of retrieving a first archived snapshot entry of a task period journal from a registry, and archiving a second snapshot entry of the task period journal in the registry, comprising:
providing a computer-implemented task management system for carrying out the method, the system, comprising:
at least one computing device in operable communication with a network;
a memory that stores computer-executable instructions;
a processor in communication with the memory and configured to execute the computer-executable instructions, wherein the computer-executable instructions invoke one or more application program components, comprising:
a task period journal module configured to provide the task period journal comprising a task table listing one or more tasks a user or team of users is assigned to complete and a notepad for documenting remarks about the one or more tasks, wherein the one or more snapshots of the task period journal is archivable in the registry comprising each of the one or more snapshots related to the one or more tasks; and
a display module configured to provide a graphical user interface for displaying a task period journal and the registry;
wherein the system is configured to create a copy of an archived snapshot of the task period journal and push the task period journal from the copy of the archived snapshot to the display on the graphical user interface when the user inputs an instruction for the system to call the archived snapshot of the task period journal from the registry;
the method further comprising:
inputting a task in the task table and/or a note in the notepad;
calling for the first archived snapshot entry of the task period journal from the registry to be displayed on the graphical user interface;
creating a copy of the first archived snapshot entry of the task period journal;
creating the second snapshot entry of the task period journal comprising the inputted task in the task table and/or the inputted note in the notepad;
saving the task period journal in the registry as the second archived snapshot entry; and
pushing the copy of the first archived snapshot entry of the task period journal to the graphical user interface for display, thereby replacing the task period journal comprising the inputted task in the task table and/or the inputted note in the notepad.

17. The computer implemented method of claim 16, wherein the saving the second snapshot entry of the task period journal in the registry is an automatic function of the system.

18. A computer implemented method of customizing a Kanban board on a personal dashboard while maintaining a generic Kanban board on a team dashboard, comprising:
providing a computer-implemented task management system for carrying out the method, the system, comprising:
at least one computing device in operable communication with a network;
a memory that stores computer-executable instructions;
a processor in communication with the memory and configured to execute the computer-executable instructions, wherein the computer-executable instructions invoke one or more application program components, comprising:
a Kanban board module configured to provide a Kanban board comprising one or more Kanban lanes and one or more Kanban cards in at least one of the one or more Kanban lanes, wherein each of the one or more Kanban cards represents a particular task, and each of the one or more Kanban cards is configured to receive a user inputted modification; and
a display module configured to provide a graphical user interface for displaying the one or more Kanban cards on the Kanban board displayed on the personal dashboard and the team dashboard;
wherein, when the one or more Kanban cards is displayed on the generic Kanban board of the team dashboard and accessible by a plurality of users, and a particular Kanban card is moved from a first Kanban lane to a second Kanban lane on the generic Kanban board, each user of the plurality of users, having an independent computing device for displaying the generic Kanban board on a graphical user interface, will see the one or more Kanban cards displayed in an identical position on the generic Kanban board before and after the particular Kanban card is moved; and
wherein, when the one or more Kanban cards is displayed on the customized Kanban board of the personal dashboard, and the particular Kanban card is moved from the first Kanban lane to the second Kanban lane on the customized Kanban board displayed on the computing device of the first user, the particular Kanban card will not be moved on the Kanban board of the personal dashboard for each of the plurality of users other than the first user;
the method further comprising;
modifying a location of the particular Kanban card on the customized Kanban board on the personal dashboard from the first Kanban lane to the second Kanban lane, wherein the particular Kanban card on the generic Kanban board on the team dashboard remains in the first Kanban lane.

19. The computer implemented method of claim 18, wherein the customized Kanban board on the personal dashboard can be closed and when reopened, the customized Kanban board displays the modified location of the particular Kanban card.

20. The computer implemented method of claim 18, wherein the computer-implemented task management system further comprises an aggregator module configured to retrieve data associated with the one or more Kanban cards on each of the independent computing devices of the plurality of users, aggregate the retrieved data, and push the aggregated data to the graphical user interface of each of the independent computing devices for display on the team dashboard and the personal dashboard; and
wherein the method further comprises:
inputting information on the particular Kanban card on the customized Kanban board on the personal dashboard;
retrieving the information inputted on the particular Kanban card; and
pushing the retrieved information to the generic Kanban card on the team dashboard and to the customized Kanban card on the customized Kanban card for each of the plurality of users.
